(19) United States
(12) Patent Application Publication
(10) Pub. No.: US 2009/0264302 A1
(43) Pub. Date: Oct. 22, 2009

(54) METHODS, SYSTEMS AND COMPUTER PROGRAM PRODUCTS FOR DETERMINING TREATMENT RESPONSE BIOMARKERS

(76) Inventor: Achim Plum, Berlin (DE)

Correspondence Address: KRIEGSMAN & KRIEGSMAN, 30 TURNPIKE ROAD, SUITE 9, SOUTHBOROUGH, MA, 01772, US

(21) Appl. No.: 12/312,269

(22) PCT Filed: Nov. 1, 2007
(86) PCT No.: PCT/IB2007/004165

§ 371 Date: May 1, 2009

(30) Foreign Application Priority Data
Nov. 1, 2006 (EP) 06123310.2

(51) Int. Cl. C40B 30/02; C40B 60/12

(52) U.S. Cl. 506/8; 506/39

(57) ABSTRACT

The invention relates to methods for the identification of biomarkers suitable for determining patient treatment response as well as systems and computer program products of use in such methods.

### BACKGROUND OF THE INVENTION

In the state of the art, methods for determining CpG positions associated with the activity of a drug are known.

US 10/087,898 describes a method comprising the following steps:

(a) obtaining a biological sample A which was exposed to said agent;

(b) obtaining a biological sample B which was not exposed to said agent;

(c) analyzing the level of cytosine methylation in the samples A and B;

(d) selecting the sites which are differentially methylated between samples A and B.

However, the disadvantages of this invention are that it does not provide any information as to what CpG positions are differentially methylated between responders to a drug and non-responders to a drug. It only allows the identification of CpG positions whose methylation pattern is altered upon treatment.

With e.g. a pharmaceutical agent, PCT/EP03/10881 describes a method for determining CpG positions indicative of response to the breast cancer treatment Tamoxifen comprising the following steps:

i. Providing a sample set of breast cancer samples of both responders and non-responders to Tamoxifen

ii. determining the CpG methylation status of selected genes

iii. determining which CpG positions are differentially methylated between said responder and non-responder groups.

A major drawback of this approach is that it requires the use of samples isolated from patients who have been treated, and who have a significant clinical follow up time (e.g. 60 months) to enable their characterization as “responders” or “non-responders” to a treatment. Furthermore in order for such an investigation to provide statistically significant and informative data the set of samples must be relatively large (in the hundreds). Sample collection is both expensive and time-consuming. Furthermore, a suitable number of samples may simply not be available, depending on how widespread the use of a particular drug is. Taking into account the above-mentioned state of the art, the problem to be solved by the invention is to provide a cost-effective method for identifying treatment response methylation markers (biomarkes). The invention solves this problem by providing a means for the identification of treatment response markers by analysis of cells (or, e.g. cell lines), which are readily available and comparatively cheaper than patient samples.

Methods for the determination of toxicological effects based on CpG analysis of cell lines are known in the art. PCT/EP01/12951 provides a method for toxicological diagnosis comprising:

i) providing a sample (from an organism or cell culture) that has been exposed to the agent of interest;

ii) determining a methylation profile of the sample by means of bisulfite analysis;

iii) comparison of said methylation profile to a standard profiles and determining therefrom upon the toxicological effect of the agent on the individual.

A major drawback of this approach is that it does not specify which CpG positions are to be analyzed for determining the toxicological effects, and furthermore how such CpG positions are to be selected from the genome. Furthermore the method is limited for determining toxicological effects and does not provide means for determining treatment response.

The present invention provides a systematic method for the efficient identification of differentially methylated genomic CpG dinucleotide sequences as markers of sensitivity or resistance to agents, in particular pharmaceutical agents.

### SUMMARY OF THE INVENTION

The present invention provides methods, systems and computer program products suitable for use in determining biomarkers indicative of sensitivity or resistance to an agent.

The central idea of the invention is to perform an analysis of the sensitivity and/or resistance of a cell to a certain agent and simultaneously to perform an analysis of the methylation state of that cell at particular genomic sites. Linking the results of both of these analyses allows determining methylation sites (biomarkers) that are indicative for a certain sensitivity and/or resistance towards the agent.

In a particularly preferred embodiment, said agent is an agent suitable for use in the treatment or therapy of diseases or other medical disorders.

Accordingly, the present invention provides a novel means for identifying biomarkers, suitable for stratifying patients according to treatment response, and thereby enables the improved disease treatment. It is particularly preferred that the present method, systems and computer code products are used in the treatment of cancer.

### DETAILED DESCRIPTION OF THE INVENTION

The present invention provides methods, systems and computer program products suitable for use in determining biomarkers indicative of sensitivity or resistance to an agent.

In a particularly preferred embodiment, said agent is an agent suitable for use in the treatment or therapy of diseases or other medical disorders. It is particularly preferred that said diseases are taken from the group consisting of unwanted side effects of medicaments; cancers; cell proliferative disorders; dysfunctions, cardiovascular diseases, malfunctions or damages; diseases, malfunctions or damages of the gastrointestinal system; diseases, malfunctions or damages of the respiratory system; injury; inflammation; infection; immunity and/or reconvalescence; diseases, malfunctions or damages as consequences of modifications in the developmental process; diseases, malfunctions or damages of the skin, muscles, connective tissue or bones; endocrine or metabolic diseases, malfunctions or damages; headache, sexual malfunctions or combinations thereof; leukemia; head and neck cancer; Hodgkin's disease; gastric cancer; prostate cancer; renal cancer; bladder cancer; breast cancer; Burkitt's lymphoma; Wilms tumor; Prader-Willi/Angelman syndrome; ICF syndrome; dermatofibroma; hypertension; pediatric neurobiological diseases; autism; damages or diseases of the central nervous system (CNS); aggressive symptoms or behavioral disorders; clinical, psychological and social consequences of brain injuries; psychotic disorders and disorders of the personality; dementia and/or associates syndromes; ulcerative colitis; fragile X syndrome; and Huntington's disease.

Accordingly it is particularly preferred that said agent is selected from the group consisting of a chemical agent, a biological agent, a pharmaceutical agent, a drug and a chemotherapeutic agent.

In a particularly preferred embodiment said agent is an agent suitable for use in the treatment or therapy of cancer, or other cell proliferative disorders. Particularly preferred is an agent suitable for use in the treatment or therapy of at least one disease selected from the group of skin cancer, lung cancer, colon cancer, rectal cancer, breast cancer, endometrial cancer, ovarian cancer and prostate cancer. Accordingly it is preferred that said agent is selected from the group consisting of alkylating agents, anti-estrogens, anti-metabolites, anti-neoplastic antibiotics, anti-neoplastic hormones, interleukins, mitotic inhibitors, small molecules and monoclonal antibodies.

Accordingly the invention is of use in the treatment and therapy of a wide variety of disease disorders.

In one aspect the present invention provides a method for determining CpG positions indicative of sensitivity or resistance to an agent. Said method comprises the following steps:

i. Determining the methylation status of a plurality of CpG positions within each of a plurality of biological samples;

ii. Exposing said biological samples to said agent;

iii. Determining the sensitivity or resistance of each of said biological samples to said agent;

iv. Classifying each of said plurality of biological samples into one of a plurality of classes according to said sensitivity or resistance; and

v. Determining at least one or more CpG positions differentially methylated between two of said classes.

Thereby, the method allows for the identification of a genetic marker whose methylation status is indicative of a certain sensitivity or of a certain resistance of the cell to a particular agent.

Said biological samples may be any suitable biological samples, including model organisms such as a bacteria, virus or rodent. Alternatively, said sample may be a biopsy or other clinical sample isolated from a human patient. In a preferred embodiment, said biological sample is a cell line. Particularly preferred are cell lines selected from the group consisting of:
CCRF-CEM (Leukemia)
HL-60(TB) (Leukemia)
K-562 (Leukemia)
MOLT-4 (Leukemia)
RPMI-8226 (Leukemia)
SR (Leukemia)
A549/ATCC (Non-Small Cell Lung)
EKVX (Non-Small Cell Lung)
HOP-62 (Non-Small Cell Lung)
HOP-92 (Non-Small Cell Lung)
NCI-H226 (Non-Small Cell Lung)
NCI-H23 (Non-Small Cell Lung)
NCI-H322M (Non-Small Cell Lung)
NCI-H460 (Non-Small Cell Lung)
NCI-H522 (Non-Small Cell Lung)
COLO 205 (Colon cancer)
HCC-2998 (Colon cancer)
HCT-116 (Colon cancer)
HCT-15 (Colon cancer)
HT29 (Colon cancer)
KM12 (Colon cancer)
SW-620 (Colon cancer)
SF-268 (Central Nervous System Cancer)
SF-295 (Central Nervous System Cancer)
SF-539 (Central Nervous System Cancer)
SNB-19 (Central Nervous System Cancer)
SNB-75 (Central Nervous System Cancer)
U251 (Central Nervous System Cancer)
LOX IMVI (Melanoma)
MALME-3M (Melanoma)
SK-MEL-2(Melanoma)
M14 (Melanoma)
SK-MEL-28 (Melanoma)
SK-MEL-5 (Melanoma)
UACC-257 (Melanoma)
UACC-62 (Melanoma)
IGROV1 (Ovarian)
OVCAR-3 (Ovarian Cancer)
OVCAR-4 (Ovarian Cancer)
OVCAR-5 (Ovarian Cancer)
OVCAR-8 (Ovarian Cancer)
SK-OV-3 (Ovarian Cancer)
786-0 (Renal Cancer)
A498 (Renal Cancer)
ACHN (Renal Cancer)
CAKI-1 (Renal Cancer)
RXF-393 (Renal Cancer)
SN12C (Renal Cancer)
TK-10 (Renal Cancer)
UO-31 (Renal Cancer)
PC-3 (Prostate Cancer)
DU-145 (Prostate Cancer)
MCF-7 (Breast cancer)
MCF7/ADR-RES (Breast cancer)
MDA-MB-231/ATCC (Breast cancer)
HS 578T (Breast cancer)
MDA-MB435 (Breast cancer)
MDA-N (Breast cancer)
BT-549 (Breast cancer)
T-47D (Breast cancer)

In a particularly preferred embodiment, said method comprises the following steps:

i. Determining the methylation status of a plurality of CpG positions within each of a first set of a plurality of biological samples;

ii. Exposing a second set of a plurality of biological samples to said agent, wherein each member of said second set of biological samples has essentially the same genotype as at least one biological sample of said first set;

iii. Determining the sensitivity or resistance of each of said second set of biological samples to said agent;

iv. Classifying each of said second set of biological samples into one of a plurality of classes according to said sensitivity or resistance; and

V. Determining at least one or more CpG positions differentially methylated between at least two of said classes, in particular by comparison of the methylation status of the a second set with the methylation status of the first set.

In other words, this preferred embodiment of the method of the invention as described above uses cells (such as cells of a cell line) that are split in two halves (sets) to undergo different treatment. One half is being treated with an agent, the effect of which on the methylation status is to be established. The other half is treated such that it can be analyzed with respect to its methylation status. The data obtained from both halves of the cells are juxtaposed (or classified), and a correlation between the two sets of data is established. Thereby, genetic methylation markers can be established that allow for the identification of a response to that particular agent.

It is preferred that in said embodiment in step ii., each biological sample of said second set of biological samples has the same genotype as (is genotypically identical to) at least one biological sample of said first set. Accordingly, for each biological sample of said second set, at least one counterpart biological sample must be present in said first sample set that has the identical, the same, or essentially the same genotype.

As used herein the term “essentially the same genotype” shall be taken to mean a homology of greater than 95%. It is particularly preferred that said homology is at least 97%, 98% or 99%.

It is particularly preferred that said biological samples are genotypically identical, or essentially genotypically identical because they have been propagated from a single ancestral cell, population of cells or cell culture. According to that, cell from a clonal cell line are preferred.

The terms “same genotype”, “genotypically identical” and “essentially the same genotype” as used herein shall apply to cloned cells, cells taken from or propagated from a single cell culture, and cells from a single cell line. As used herein, the terms “same genotype”, “genotypically identical” and “essentially the same genotype” shall apply to all biological samples taken from an individual organism.

In the first step (i) of said methods, the methylation status of a plurality of CpG positions within each of a plurality of biological samples is determined.

It is particularly preferred that at least 2, 5, 10, 20, 30, 50, 75 or 100 classes of biological samples are analyzed wherein each class of samples is genotypically distinct from the other classes. The term genotypically distinct shall be taken to mean a homology of less than 99%. It is particularly preferred that said homology is less than 95%, 96% or 97%.

It is particularly preferred that the methylation status of at least 50, 100, 1000, 2000, 3000, 4000 or 5000 CpG positions is determined. It is preferred that said CpG positions are not located within repetitive elements of the genome. The term repetitive element shall be taken to include, for example, SINES, LINES and Alu repeat elements.

It is preferred that at least 50%, 60%, 70% or 80% of said CpG positions are located within the promoter or regulatory regions of genes. It is further preferred that at least 50%, 60%, 70% or 80% of said CpG positions are located within the region of said genes starting 3000 base pairs (bp) upstream of the transcription start site thereof until the end of the first exon.

It is particularly preferred that at least 50%, 60%, 70% or 80% of said CpG positions are located within CpG dense regions, preferably CpG islands. The term “CpG island” refers to a contiguous region of genomic DNA that satisfies the criteria of (1) having a frequency of CpG dinucleotides corresponding to an “Observed/Expected Ratio” >0.6, and (2) having a “GC Content” >0.5. CpG islands are typically, but not always, between about 0.2 to about 1 kilobase (kb), or to about 2 kb in length.

In the first step (i) of said methods the methylation state or status of a plurality of CpG positions within each of a plurality of biological samples is determined. It is preferred that at least 10, 20, 30, 50 or 70 biological samples are analyzed. It is preferred that said plurality of biological samples comprises a plurality of distinct genotypes or phenotypes. Preferably said set comprises at least 2, 5, 10, 20, 30, 50 or 70 distinct genotypes or phenotypes.

It is particularly preferred that said biological samples consist of cell lines or cell cultures. In the first step (i) of said methods the methylation state or status of a plurality of CpG positions may be determined by any suitable means known in the art. Preferred is the use of a method selected from the group consisting of differential methylation hybridization (DMH); restriction landmark genomic scanning (RLGS); methylation sensitive arbitrarily primed PCR (AP-PCR); methylated CpG island amplification (MCA) and combinations thereof However it is particularly preferred that said means is selected from the group consisting of by a means comprising the use of methylation sensitive restriction enzymes. Particularly preferred is the use of differential methylation hybridization (DMH).

In the first step of such methods, the genomic DNA sample is isolated, preferably from tissue or cellular sources. Genomic DNA may be isolated by any means standard in the art, including the use of commercially available kits. Briefly, wherein the DNA of interest is encapsulated in by a cellular membrane the biological sample must be disrupted and lyzed by enzymatic, chemical or mechanical means. The DNA solution may then be cleared of proteins and other contaminants, e.g., by digestion with proteinase K. The genomic DNA is then recovered from the solution. This may be carried out by means of a variety of methods including salting out, organic extraction or binding of the DNA to a solid phase support. The choice of method will be affected by several factors including time, expense and required quantity of DNA.

Once the nucleic acids have been extracted, the genomic double-stranded DNA is used in the analysis.

In a preferred embodiment, the DNA may be cleaved prior to treatment with methylation sensitive restriction enzymes. Such methods are known in the art and may include both physical and enzymatic means. Particularly preferred is the use of one or a plurality of restriction enzymes which are not methylation sensitive, and whose recognition sites are AT rich and do not comprise CG dinucleotides. The use of such enzymes enables the conservation of CpG islands and CpG rich regions in the fragmented DNA. The non-methylation-specific restriction enzymes are preferably selected from the group consisting of MseI, BfaI, Csp6I, Tru1I, Tvu1I, Tru9I, Tvu9I, MaeI and XspI. Particularly preferred is the use of two or three such enzymes. Particularly preferred is the use of a combination of MseI, BfaI and Csp6I.

The fragmented DNA may then be ligated to adaptor oligonucleotides in order to facilitate subsequent enzymatic amplification. The ligation of oligonucleotides to blunt and sticky ended DNA fragments is known in the art, and is carried out by means of dephosphorylation of the ends (e.g. using calf or shrimp alkaline phosphatase) and subsequent ligation using ligase enzymes (e.g. T4 DNA ligase) in the presence of dATPs. The adaptor oligonucleotides are typically at least 18 base pairs in length.

In the third step, the DNA (or fragments thereof) is then digested with one or more methylation sensitive restriction enzymes.

Preferably, the methylation-specific restriction enzyme is selected from the group consisting of Bs1 E1, Hga I HinPl, Hpy99I, Ava I, Bce AI, Bsa HI, BisI, BstUI, BshI236I, AccII, BstFNI, McrBC, GlaI, MvnI, HpaII (HapII), HhaI, AciI, Smal, HinP1I, HpyCH4IV, EagI and mixtures of two or more of the above enzymes. Preferred is a mixture containing the restriction enzymes BstUI, HpaII, HpyCH4IV, and HinP1I.

In the fourth step, which is optional but preferred, the restriction fragments are amplified. This is preferably carried out using a polymerase chain reaction, and said amplificates may carry suitable detectable labels as discussed above, namely fluorophore labels, radionuclides and mass labels. Particularly preferred is amplification by means of an amplification enzyme and at least two primers. In an alternative embodiment said primers may be complementary to any adaptors linked to the fragments.

In the fifth step the amplificates are detected. The detection may be by any means standard in the art, for example, but not limited to, gel electrophoresis analysis, hybridization analysis, incorporation of detectable tags within the PCR products, DNA array analysis, MALDI or ESI analysis. Preferably said detection is carried out by hybridization to at least one nucleic acid or peptide nucleic acid comprising in each case a contiguous sequence at least 16 nucleotides in length. Preferably said contiguous sequence is at least 16, 20 or 25 nucleotides in length.

In the second (ii) step of the method the biological samples are exposed to the agent of interest. In one embodiment said biological samples are the biological samples of the first or preceding step (i). In a preferred embodiment said biological samples are a second set of a plurality of biological samples, wherein each member of said second set of biological samples has essentially the same genotype as at least one biological sample of said first set of the first, or preceding step (i).

It is further preferred that said second set of biological samples has the same or an identical genotype as at least one biological sample of said first set of the first, or preceding step (i). Accordingly for each biological sample of the second set there is a counterpart biological sample in the first sample set of the first, or preceding step (i) that has the same, essentially the same or an identical genotype.

It is particularly preferred that said agent is selected from the group consisting of alkylating agents, anti-estrogens, anti-metabolites, anti-neoplastic antibiotics, anti-neoplastic hormones, interleukins, mitotic inhibitors, small molecules and monoclonal antibodies.

Said exposure is preferably controlled in terms of duration of exposure and/or amount of agent.

In the third (iii) step of the method the sensitivity or resistance of each of the biological sample exposed in the preceding step (ii) to said agent is determined.

It is preferred that said sensitivity or resistance is expressed as a quantitative value. It is further preferred that said quantitative value is then used to classify the biological sample.

Preferably said sensitivity or resistance is determined according to cell viability, quantification of the proportion of live to dead cells, cell proliferation or cell apoptosis.

Methods for determining the sensitivity or resistance of a biological sample to an agent are known in the art and are routinely carried out in drug screening. Sensitivity or resistance may be determined in vivo by exposing the biological sample (most preferably a cell line) to the agent of interest. Said exposure is preferably controlled in terms of duration of exposure and/or amount of agent. At a determined end point, or a plurality of end points, sensitivity and/or resistance is determined by measuring at least one parameter selected from the group consisting of cell viability, cell apoptosis, cell proliferation or other live-cell functions. A biological sample is determined as sensitive according to said quantified parameter(s) with reference to a cut-off value. A biological sample is determined as resistant according to said quantified parameter(s) with reference to a cut-off value. Wherein a plurality of parameters is determined the determination of sensitivity or resistance is to be determined taking into account each of the quantified parameters by reference to their individual cut-off value. Assays for determining cell viability, cell apoptosis, cell proliferation and other live-cell functions are known in the art. Cell viability assays quantify the proportion of living and dead cells in a sample. Commonly used viability assays include staining. Trypan blue and propidium iodide do not stain viable cells, whereas CFDA, neutral red and crystal violet stain living cells only. Cell mediated cytotoxicty can also be measured by means of ⁵¹Cr release or Europium Titriplex V from labeled cells or by measuring LDH activity in cell culture media. Cell viability can also be measured by measuring alamar blue reduction.

Cell proliferation assays monitor the growth rate of a cell population or determine the presence of daughter cells in a cell population. Commonly used cell proliferation assays include the use of antigens specific to proliferating cells (for example but not limited to Ki-67, PCNA, cyclin E and other cell cycle associated proteins), ³H-Thymidine or bromodeoxyuridine incorporation, neutral red uptake, tetrazolium salt or alamar blue reduction.

Cell apoptosis assays quantify the proportion of apoptotic cells in a sample. Said assays detect properties associated with programmed cell death such as cell permeability, loss of plasma membrane integrity, chromatin condensation and phosphatidylserine exposure.

Other commonly assay features include important live cell functions such as cell adhesion, chemotaxis, multidrug resistance, endocytosis, secretion and signal transduction. Many of these processes result in observable changes in intracellular radicals, free ion concentration.

Although many of the assays may be motored using radioisotopic or calorimetric techniques, it is particularly preferred that said assays are based on fluorescent dye techniques.

The person skilled in the art will be capable of selecting an appropriate assay based on the agent used, the effects to be observed, the cell strains and culture medias used.

In the fourth (iv) step of the method each member of the set of biological samples exposed to the agent is classified. Each sample is assigned to one of a plurality of classes according to according to the sensitivity or resistance determined in the preceding step (iii). Preferably each sample is assigned to one of 2, 3, 4, or 5 of classes. Preferably each of said plurality of biological samples is classified into one of two classes according to said sensitivity or resistance. In one embodiment said classes are responder and non-responder. In another embodiment said classes are resistant and not-resistant.

Wherein each of the biological samples is assigned a quantitative value of sensitivity or resistance, the assignment of a sample to a particular class is preferably carried out on the basis of cut-off values determined by the person skilled in the art.

In the final step of the method at least one or more CpG positions differentially methylated between two of said classes is determined. In one embodiment said classes are responder and non-responder. In another embodiment said classes are resistant and not-resistant.

Wherein a plurality of CPG positions are differentially methylated between a given pair of classes it is preferred that said CpG positions are ranked according to the difference in methylation between said classes.

In one embodiment the invention provides a system for determining methylation markers comprising:

(A) a device or apparatus comprising:

a dataset of a methylation profile of each of a plurality of biological samples;

(B) means for providing a sensitivity or resistance profile for at least one, and more preferably each, of said biological samples;

(C) means for generating in said device a classification of each of said plurality of biological samples into one of a plurality of classes according to said sensitivity or resistance; and

(D) means for determining CpG positions differentially methylated between selected classes.

It is particularly preferred that said device or apparatus is a computing device. It is preferred that the dataset according to (A) is stored on a computer accessible means (e.g. electronic database, CD-ROM, DVD-ROM, random access memory, read-only memory, disk, virtual memory or processor).

The device or apparatus may further comprise a storage mechanism, wherein the storage mechanism stores the dataset according to (A); an input device that inputs the sensitivity or resistance profile according to (B) into the apparatus. The system further comprises a means for generating in said device a classification of each of said plurality of biological samples into one of a plurality of classes according to said sensitivity or resistance according to (C) and algorithmic means for determining in said device CpG positions differentially methylated between selected classes.

It is particularly preferred that said device or apparatus comprises a processor. The processor may be a multi-purpose or a dedicated processor. The storage mechanism may be random access memory, read-only memory, a disk, virtual memory, a database, and a processor.

The system preferably comprises an input device that inputs the sensitivity or resistance profile according to (B) into the apparatus. It is preferred that the input device stores the identical set of factors in a storage mechanism that is accessible by a processor. The input device may be a keypad, a keyboard, stored data, a touch screen, a voice activated system, a downloadable program, downloadable data, a digital interface, a hand-held device, or an infra-red signal device. The display mechanism may be a computer monitor, a cathode ray tub(CRI), a digital screen, a light-emitting diode (LED), a liquid crystal display (LCD), an X-ray, a compressed digitized image, a video image, or a hand-held device.

The system may further comprise a display mechanism, wherein the display mechanism displays CpG positions differentially methylated between selected classes.

In a further embodiment the invention provides a distributed system for determining methylation markers comprising:

(A) a computing device comprising:

a first dataset of a methylation profile of each of a plurality of biological samples;

(B) means for providing a sensitivity or resistance profile for at least one, more preferably each, of plurality of biological samples;

(C) means for correlating each member of said second set of samples with the members of said first dataset;

(D) means for generating in said computing device a classification of each of said plurality of biological samples of said first dataset into one of a plurality of classes according to said sensitivity or resistance; and

(E) means for determining CpG positions differentially methylated between selected classes.

The various embodiments of the invention may be also implemented as a computer program product for use with a computer system. The product may include program code for a methylation profile of each of a plurality of biological samples. The product may further include program code for a sensitivity or resistance profile for at least one of said biological samples. Preferably the product may further include program code for a sensitivity or resistance profile for each of said biological samples. The product may further include program code for generating in a computing device a classification of each of said plurality of biological samples into one of a plurality of classes according to said sensitivity or resistance. The product may further include program code computer readable program code means for determining CpG positions differentially methylated between selected classes.

Such implementation may include a series of computer instructions fixed either on a tangible medium, such as a computer readable medium (for example, a diskette, CD-ROM, ROM, or fixed disk), or transmittable to a computer system via a modem or other interface device, such as a communications adapter coupled to a network. The network coupling may be for example, over optical or wired communications lines or via wireless techniques (for example, microwave, infrared or other transmission techniques) or some combination of these. The series of computer instructions preferably embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (for example, shrink wrapped software), preloaded with a computer system (for example, on system ROM or fixed disk), or distributed from a server or electronic bulletin board over a network (for example, the Internet or World Wide Web). In addition, a computer system is further provided including derivative modules for deriving a first data set and a calibration profile data set.

It is particularly preferred that the dataset of methylation profile of each of a plurality of biological samples of (A) may be available as a computer program product for determining methylation markers comprising a computer usable storage medium having computer readable program code means embodied in the medium, the computer readable program code means comprising:

(A) a computer readable dataset of a methylation profile of each of a plurality of biological samples,

(B) computer readable program code means for providing a sensitivity or resistance profile for at least one, more preferably each, of said biological samples;

(C) computer readable program code means for generating in said computing device a classification of each of said plurality of biological samples into one of a plurality of classes according to said sensitivity or resistance

(D) computer readable program code means for determining CpG positions differentially methylated between selected classes.

The storage medium may be random access memory, read-only memory, a disk, virtual memory, a database, and a processor.

It is particularly preferred that said computer program product may be available on portable or other computing devices (e.g. PDA, internet accessible, available on a portable storage medium).

### DEFINITIONS

The terms “pharmaceutical agent” and “drug” shall be taken to mean any substance used to prevent, treat, or relieve symptoms of a disease or abnormal condition. Particularly preferred according to the present invention are those substances listed under the Anatomical Therapeutic Classification (AT) developed by the European Pharmaceutical Market Research Association (EPhMRA) or the Anatomical Therapeutic Chemical Classification System developed by the World Health Organisation (WHO).

The term chemotherapeutic agent shall be taken to mean any substance used to prevent, treat, or relieve symptoms of a cancer.

The term classification shall be taken to mean the assignment of an object to one of a plurality of discontinuous groupings of said objects. According to the present invention it is preferred that said objects are biological samples.

The term “drug resistance” and “resistance” shall be taken to mean the ability of diseased cells to become resistant to the effects of a pharmaceutical agent. The cells may be resistant to a drug at the beginning of treatment, or may become resistant after being exposed to the drug.

The term “sensitivity” as used herein in reference to an agent or a drug shall be taken to mean the susceptibility of an organism or cell to any effects thereof, in particular therapeutic effects. For example, HER2-positive breast cancer cells are sensitive to the effects of Herceptin (Trastuzumab) whereas HER2-negative breast cancer cells are not.

Accordingly, when used in reference to a pharmaceutical agent the term “sensitivity” has the opposite meaning of the term “resistance”.

The term “cell line” shall be taken to mean a defined population of cells which has been maintained in a culture for an extended period and which has usually undergone a spontaneous process of transformation conferring an unlimited culture lifespan on the cells.

The term “small molecule” is commonly used in the field of cancer therapeutics to indicate a chemical or biological entity that is developed on the basis of structure-function analysis of a cellular feature (e.g. a protein) of the cancer cell with which they should interfere. Examples of small molecules include tyrosine kinase inhibitors (TKIs),such as Gleevec® (imatinib mesylate), Iressa® (gefitinib), Tarceva™ (erlotinib HCl)and Omnitarg™ (pertuzumab).

The term “methylation state” or “methylation status” refers to the presence or absence of 5-methylcytosine (“5-mCyt”) at one or a plurality of CpG dinucleotides within a DNA sequence. Methylation state may be determined as a quantitative value, including % or fraction.

Unless specifically stated the terms “hypermethylated” or “upmethylated” shall be taken to mean a methylation level above that of a specified cut-off point, wherein said cut-off may be a value representing the average or median methylation level for a given population, or is preferably an optimized cut-off level. The “cut-off” is also referred herein as a “threshold”. In the context of the present invention the preferred cut-off values include zero (0) %, five (5) %, ten (10) %, twenty (20) % (or equivalents thereof).

1. A method for determining CpG positions indicative of sensitivity or resistance to an agent comprising
i. Determining the methylation status of a plurality of CpG positions within each of a plurality of biological samples
ii. Exposing said biological samples to said agent
iii. Determining the sensitivity or resistance of each of said biological samples to said agent
iv. Classifying each of said plurality of biological samples into one of a plurality of classes according to said sensitivity or resistance
v. Determining at least one or more CpG positions differentially methylated between two of said classes.

2. The method according to claim 1, wherein in i., determining the methylation status is carried out by means of methylation sensitive restriction enzymes.

3. The according to claim 1, wherein in i., determining the methylation status is carried out by means of a method selected from the group comprising differential methylation hybridization (DMH); restriction landmark genomic scanning (RLGS); methylation sensitive arbitrarily primed PCR (AP-PCR); methylated CpG island amplification (MCA) and combinations thereof.

4. The method according to claim 1, wherein in i., the methylation status of at least 1000 CpG positions is determined.

5. The method according to claim 1, wherein said set of a plurality of biological samples each comprises at least 20 biological samples.

6. The method according to claim 1, wherein said biological samples are cell lines.

7. The method according to claim 1, wherein in ii., said agent is selected from the group consisting of a chemical agent, a biological agent, a pharmaceutical agent, a drug, and a chemotherapeutic agent.

8. The method according to claim 1, wherein in ii., said agent is selected from the group consisting of alkylating agents, anti-estrogens, anti-metabolites, anti-neoplastic antibiotics, anti-neoplastic hormones, interleukins, mitotic inhibitors, small molecules and monoclonal antibodies.

9. The method according to claim 1, wherein in iii., sensitivity or resistance is determined according to cell viability, quantification of the proportion of live to dead cells, cell proliferation or cell apoptosis.

10. The method according to claim 1, wherein in iv., each of said plurality of biological samples is classified into one of two classes according to said sensitivity or resistance.

11. The method according to claim 1, wherein in v., said CpG positions are ranked according to the difference in methylation between said classes.

12. A system for determining methylation markers, comprising:
(A) a computing device comprising:
a dataset of a methylation profile of each of a plurality of biological samples;
(B) means for providing a sensitivity or resistance profile for each of said biological samples;
(C) means for generating in said computing device a classification of each of said plurality of biological samples into one of a plurality of classes according to said sensitivity or resistance; and
(D) means for determining CpG positions differentially methylated between selected classes.

13. A distributed system for determining methylation markers, comprising:
(A) a computing device, comprising:
a first dataset of a methylation profile of each of a plurality of biological samples;
(B) means for providing a sensitivity or resistance profile for each of said biological samples;
(C) means for correlating each member of said second set of samples with the members of said first dataset;
(D) means for generating in said computing device a classification of each of said plurality of biological samples of said first dataset into one of a plurality of classes according to said sensitivity or resistance; and
(E) means for determining CpG positions differentially methylated between selected classes.

14. A computer program product for determining methylation markers comprising a computer usable storage medium having computer readable program code means embodied in the medium, the computer readable program code means comprising:
(A) a computer readable dataset of a methylation profile of each of a plurality of biological samples;
(B) computer readable program code means for providing a sensitivity or resistance profile for each of said biological samples;
(C) computer readable program code means for generating in said computing device a classification of each of said plurality of biological samples into one of a plurality of classes according to said sensitivity or resistance; and
(D) computer readable program code means for determining CpG positions differentially methylated between selected classes.
